(19) United States
(12) Patent Application Publication
(10) Pub. No.: US 2025/0327334 A1
(43) Pub. Date: Oct. 23, 2025

(54) LOCK CORE DEVICE, LOCK CORE DEVICE RESETTING METHOD AND LOCK CORE DEVICE DESIGN METHOD

(71) Applicant: TAIWAN FU HSING INDUSTRIAL CO., LTD., Kaohsiung City (TW)

(72) Inventors: Chao-Ming HUANG, Kaohsiung City (TW); Chi-Ming CHEN, Kaohsiung City (TW)

(21) Appl. No.: 19/256,591

(22) Filed: Jul. 1, 2025

Related U.S. Application Data
(63) Continuation-in-part of application No. 18/304,554, filed on Apr. 21, 2023.

(30) Foreign Application Priority Data
Feb. 10, 2023 (TW) 112104768
Jul. 31, 2024 (TW) 113128600

(51) Int. Cl. E05B 27/00

(52) U.S. Cl. CPC E05B 27/005

(57) ABSTRACT

A lock core device includes a receiving sleeve and a lock cylinder rotatable relative to the receiving sleeve. The lock cylinder is formed with a keyway to selectively receive a first type key with a first section contour or a second type key with a second section contour different from the first section contour. A first side of the keyway is formed with a first abutting structure to allow the first type key to abut against in order to position a bottom of the first type key relative to the keyway along a height direction of the keyway. A second side of the keyway is formed with a second abutting structure to allow the second type key to abut against in order to position a bottom of the second type key relative to the keyway along the height direction of the keyway. The first and second sides are opposite sides.

### CROSS REFERENCE TO RELATED APPLICATIONS

This application is a Continuation-in-Part of co-pending application Ser. No. 18/304,554, filed on Apr. 21, 2023, for which priority is claimed under 35 U.S.C. § 120; and this application claims priority of application No. 113128600 filed in Taiwan on Jul. 31, 2024 and application No. 112104768, filed in Taiwan on Feb. 10, 2023, under 35 U.S.C. § 119, the entire contents of all of which are hereby incorporated by reference.

### BACKGROUND OF THE INVENTION

### 1. Field of the Invention

The present invention relates to a lock core device, and more particularly, to a lock core device applicable to different types of keys.

### 2. Description of the Prior Art

Generally, a lock core device comprises a plurality of lock balls in a lock cylinder to work with a key in order to perform locking and unlocking operations. For example, when heights of teeth of the key corresponds to variances in length of the lock balls in the lock cylinder, the key can rotate the lock cylinder to perform locking and unlocking operations; when heights of teeth of the key does not correspond to variances in length of the lock balls in the lock cylinder, the key cannot rotate the lock cylinder to perform locking and unlocking operations. For requirements of replacing the key, the lock balls in the lock cylinder of the lock core device of the prior art must be replaced in order to allow variances in length of new lock balls in the lock cylinder to correspond to heights of teeth of a new key. However, the above replacing process of the lock balls is quite complicated. Moreover, the lock cylinder of the lock core device of the prior art is not applicable to keys with different section contours. The keys with different section contours have different tooth level systems. In addition to different heights of the teeth along a longitudinal direction of the keys, height differences between two adjacent teeth of the keys are different. Therefore, keys with different section contours require different lock cylinders (to correspond to the heights of the teeth along the longitudinal direction of the keys) and different lock balls (to correspond to the height differences between two adjacent teeth of the keys).

### SUMMARY OF THE INVENTION

The present invention aims to provide a lock core device, a lock core device resetting method and a lock core device design method in order to solve the problems of the prior art.

The lock core device resetting method of the present invention comprises providing a lock core device, wherein the lock core device comprises a receiving sleeve, a lock cylinder rotatable relative to the receiving sleeve, a plurality of tooth level blocks movably arranged in the lock cylinder, and a plurality of positioning members movably arranged in the lock cylinder, wherein the plurality of tooth level blocks are respectively engaged with the plurality of positioning members according to heights of tooth levels of a first type key; inserting the first type key into a keyway of the lock cylinder and using the first type key to rotate the lock cylinder relative to the receiving sleeve from a first predetermined position to a second predetermined position; disengaging the plurality of positioning members from the plurality of tooth level blocks; removing the first type key from the lock cylinder and inserting a second type key into the keyway of the lock cylinder to move the plurality of tooth level blocks relative to the lock cylinder, wherein a section contour of the second type key is different from a section contour of the first type key; engaging the plurality of tooth level blocks with the plurality of positioning members respectively according heights of tooth levels of the second type key; using the second type key to rotate the lock cylinder relative to the receiving sleeve from the second predetermined position to the first predetermined position; and removing the second type key from the lock cylinder.

In the lock core device design method, the lock core device comprises a receiving sleeve, a lock cylinder rotatable relative to the receiving sleeve, a plurality of tooth level blocks movably arranged in the lock cylinder, and a plurality of positioning members movably arranged in the lock cylinder. The lock core device design method comprises determining a contour of a keyway of the lock cylinder according to a first section contour of a first type key and a second section contour of a second type key, wherein the keyway is formed with a first abutting structure configured to allow the first type key to abut against, and a second abutting structure configured to allow the second type key to abut against; selecting a reference height of the tooth level block and a basic spacing between two adjacent engaging structures of the plurality of engaging structures on the positioning member, wherein the tooth level block is configured to be engaged with the engaging structure on the positioning member; determining whether an absolute value of a difference between each of the heights of tooth levels of the first type key and the reference height plus a corresponding integer multiple of the basic spacing is smaller than a predetermined value according to a position of the first abutting structure; and determining whether an absolute value of a difference between each of the heights of tooth levels of the second type key and the reference height plus a corresponding integer multiple of the basic spacing is smaller than the predetermined value according to a position of the second abutting structure.

The lock core device of the present invention comprises a receiving sleeve, a lock cylinder rotatable relative to the receiving sleeve, a plurality of tooth level blocks movably arranged in the lock cylinder and a plurality of positioning members movably arranged in the lock cylinder. The lock cylinder is formed with a keyway configured to selectively receive a first type key with a first section contour or a second type key with a second section contour different from the first section contour. The plurality of tooth level blocks are configured to be engaged with the plurality of positioning members respectively according to heights of tooth levels of the first type key or heights of tooth levels of the second type key. A highest tooth level of the first type key is different from a highest tooth level of the second type key, and/or a lowest tooth level of the first type key is different from a lowest tooth level of the second type key.

The lock core device of the present invention comprises a receiving sleeve and a lock cylinder rotatable relative to the receiving sleeve. The lock cylinder is formed with a keyway configured to selectively receive a first type key with a first section contour or a second type key with a second section contour different from the first section contour. A first side of the keyway is formed with a first abutting structure configured to allow the first type key to abut against in order to position a bottom of the first type key relative to the keyway along a height direction of the keyway. A second side of the keyway is formed with a second abutting structure configured to allow the second type key to abut against in order to position a bottom of the second type key relative to the keyway along the height direction of the keyway. The first side and the second side are opposite sides.

The lock core device of the present invention comprises a receiving sleeve and a lock cylinder rotatable relative to the receiving sleeve. The lock cylinder is formed with a keyway configured to selectively receive a first type key or a second type key. The keyway is formed with a first abutting structure configured to allow the first type key to abut against in order to position a bottom of the first type key at a first position relative to the keyway along a height direction of the keyway. The keyway is formed with a second abutting structure configured to allow the second type key to abut against in order to position a bottom of the second type key at a second position relative to the keyway along the height direction of the keyway. A distance between the first position and a bottom of the keyway is different from a distance between the second position and the bottom of the keyway.

The lock core device of the present invention comprises a receiving sleeve, a lock cylinder rotatable relative to the receiving sleeve, a plurality of tooth level blocks movably arranged in the lock cylinder, and a plurality of positioning members movably arranged in the lock cylinder. The lock cylinder is formed with a keyway configured to selectively receive a first type key or a second type key. Each of the positioning members is formed with a plurality of engaging structures, and a basic spacing is defined between two adjacent engaging structures. The plurality of tooth level blocks are configured to be engaged with the engaging structures of the plurality of positioning members respectively according to heights of tooth levels of the first type key or heights of tooth levels of the second type key. A height difference between two adjacent tooth levels of one of the first type key and the second type key is not a positive integer multiple of the basic spacing.

The lock core device of the present invention comprises a receiving sleeve, a lock cylinder rotatable relative to the receiving sleeve, a plurality of tooth level blocks movably arranged in the lock cylinder, and a plurality of positioning members movably arranged in the lock cylinder. The lock cylinder is formed with a keyway configured to selectively receive a first type key with a first section contour or a second type key with a second section contour. The first section contour is different from the first section contour. Each of the positioning members is formed with a plurality of engaging structures, and the plurality of tooth level blocks are configured to be engaged with the engaging structures of the plurality of positioning members respectively according to heights of tooth levels of the first type key or heights of tooth levels of the second type key. A height difference between two adjacent tooth levels of the first type key is different from a height difference between two adjacent tooth levels of the second type key.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a lock core device of the present invention;

FIG. 2 is an exploded view of the lock core device of the present invention;

FIG. 3 is a diagram showing an outer contour of a keyway of a lock cylinder of the present invention;

FIG. 4 is a diagram showing processes of resetting the lock core device of the present invention;

FIG. 5 is a diagram showing processes of resetting the lock core device of the present invention;

FIG. 6 is a diagram showing a slot of the lock cylinder of the present invention;

FIG. 7 is a diagram showing a tooth level block being engaged with a positioning member at a highest position;

FIG. 8 is a diagram showing the tooth level block being engaged with the positioning member at a lowest position; and

FIG. 9 is a flow chart of a lock core device design method of the present invention.

FIG. 10 is a diagram showing tooth level configurations of the first type key and the second type key according to another embodiment of the present invention.

FIG. 11 is a diagram showing tooth level configurations of the first type key and the second type key according to another embodiment of the present invention.

FIG. 12 is a diagram showing tooth level configurations of the first type key and the second type key according to another embodiment of the present invention.

### DETAILED DESCRIPTION

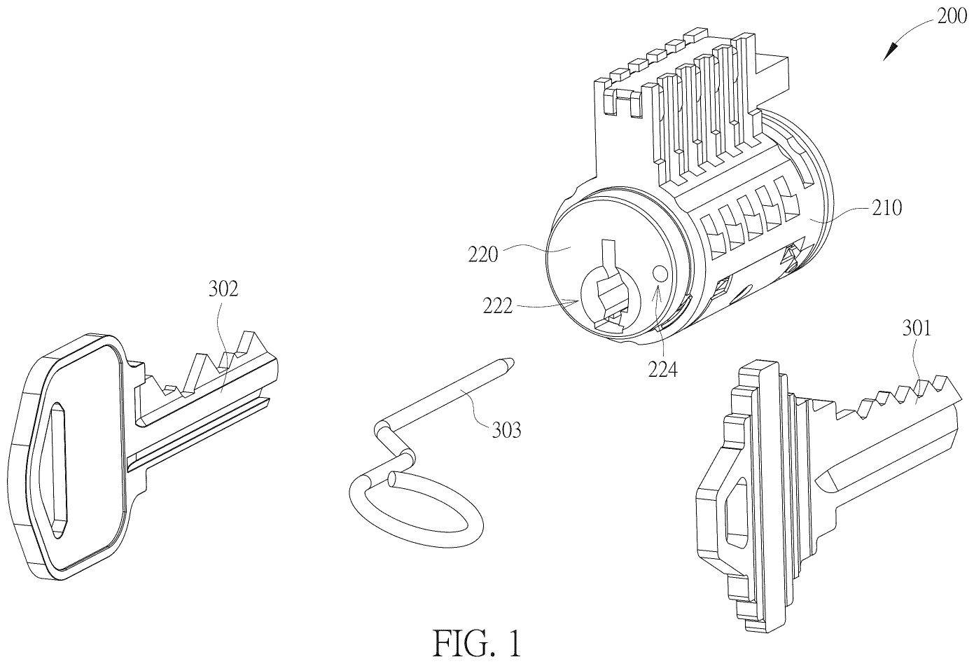

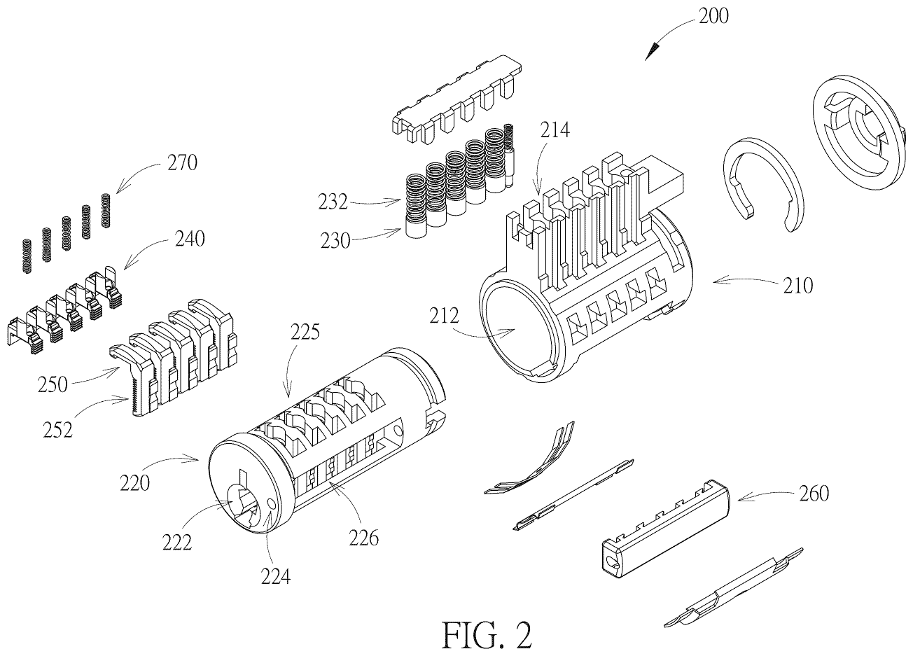

Please refer to FIG. 1 and FIG. 2. FIG. 1 is a diagram showing a lock core device of the present invention. FIG. 2 is an exploded view of the lock core device of the present invention. As shown in figures, the lock core device 200 of the present invention comprises a receiving sleeve 210, a lock cylinder 220, a plurality of lock balls 230, a plurality of tooth level blocks 240 and a plurality of positioning members 250. The receiving sleeve 210 is formed with a lock cylinder hole 212 and a plurality of lock ball holes 214. The lock cylinder 220 is accommodated in the lock cylinder hole 212 of the receiving sleeve 210 and is rotatable relative to the receiving sleeve 210. The lock cylinder 220 is formed with a keyway 222 and a setting hole 224. The keyway 222 is configured to selectively receive a first type key 301 or a second type key 302. The setting hole 224 is configured to be inserted with a setting tool 303 to reset the lock core device 200. The plurality of lock balls 230 are respectively accommodated in the plurality of lock ball holes 214 of the receiving sleeve 210, and lengths of the plurality of lock balls 214 are identical. The plurality of tooth level blocks 240 are movably arranged in a plurality of slots 225 of the lock cylinder 220 respectively. The plurality of positioning members 250 are movably arranged in the plurality of slots 225 of the lock cylinder 220 respectively. A plurality of engaging structures 252 are formed on the positioning member 250. The plurality of tooth level blocks 240 are configured to be engaged with the plurality of engaging structures 252 of the positioning member 250 respectively according to heights of teeth of a key.

In addition, the lock core device 200 further comprises a plurality of lock ball springs 232 respectively accommodated in the plurality of lock ball holes 214 and configured to push the plurality of lock balls 230 toward the lock cylinder 220. Moreover, the lock core device 200 further comprises a setting rod 260 movably arranged in a notch 226 of the lock cylinder 220.

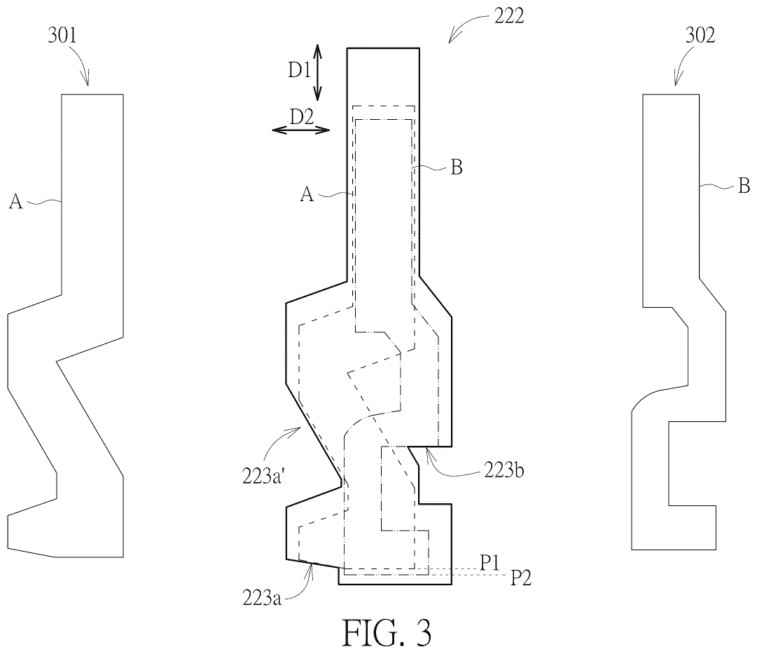

Please refer to FIG. 3, and FIG. 1 and FIG. 2 as well. FIG. 3 is a diagram showing an outer contour of the keyway of the lock cylinder of the present invention. As shown in figures, the keyway 222 is configured to selectively receive a first type key 301 with a first section contour A or a second type key 302 with a second section contour B different from the first section contour A. For example, the outer contour of the keyway 222 is greater than or equal to an outer contour after the first section contour A and the second section contour Bare superimposed. Therefore, the keyway 222 can selectively receive one of the first type key 301 with the first section contour A or the second type key 302 with the second section contour B. In FIG. 3, shapes of the first section contour A and the second section contour B are merely examples, and the present invention is not limited thereto. The shapes of the first section contour A and the second section contour B can be changed according to usage and design requirements. The first type key 301 and the second type key 302 are movable relative to the keyway 222 within a predetermined height range along a height direction D1 of the keyway 222.

In the present invention, the section contours of the first type key 301 and the second type key 302 are different. Specifically, a section contour of a key is a contour of a predetermined portion of the key configured to be inserted into a keyway without being formed with teeth. When the key is inserted into the keyway, the predetermined portion of the key is adjacent to an entrance of the keyway. When the section contour of the first type key 301 and the section contour of the second type key 302 are superimposed, at least a portion of the section contour of the first type key 301 does not overlap with the section contour of the second type key 302, and at least a portion of the section contour of the second type key 302 does not overlap with the section contour of the first type key 301.

In addition, a first side of the keyway 222 is formed with a first abutting structure 223a configured to allow the first type key 301 to abut against in order to position a bottom of the first type key 301 at a first position P1 relative to the keyway 222 along the height direction D1 of the keyway 222. A second side of the keyway 222 is formed with a second abutting structure 223b configured to allow the second type key 302 to abut against in order to position a bottom of the second type key 302 at a second position P2 relative to the keyway 222 along the height direction D1 of the keyway 222. The first side of the keyway 222 and the second side of the keyway 222 are opposite sides (such as a left side and a right side) of the keyway 222. In the present embodiment of the present invention, a distance between the first position P1 and the bottom of the keyway 222 is different from a distance between the second position P2 and the bottom of the keyway 222, but the present invention is not limited thereto. On the other hand, the first type key 301 is not configured to abut against the second abutting structure 223b, and the second type key 302 is not configured to abut against the first abutting structure 223a.

In the present embodiment of the present invention, the first abutting structure 223a of the keyway 222 corresponds to the bottom of the first type key 301 in order to position the first type key 301 relative to the keyway 222 along the height direction D1 of the keyway 222, and the second abutting structure 223b of the keyway 222 corresponds to a middle portion of the second type key 302 in order to position the second type key 302 relative to the keyway 222 along the height direction D1 of the keyway 222, but the present invention is not limited thereto. In other embodiment of the present invention, the keyway 222 may also be formed with a first abutting structure (such as an abutting structure 223a′) at another position on the first side of the keyway 222 in order to position the first type key 301 relative to the keyway 222 along the height direction D1 of the keyway 222. Moreover, the keyway 222 can also be formed with a second abutting structure (not shown in figures) at another position on the second side of the keyway 222 in order to position the second type key 302 relative to the keyway 222 along the height direction D1 of the keyway 222. Alternatively, a bottom of the keyway 222 can also be in an open shape without a boundary wall, and the first and second abutting structures are formed on the receiving sleeve 210. In the present embodiment, the first and second abutting structures can be formed on proper positions to position the first type key 301 and the second type key 302 along the height direction D1 of the keyway 222.

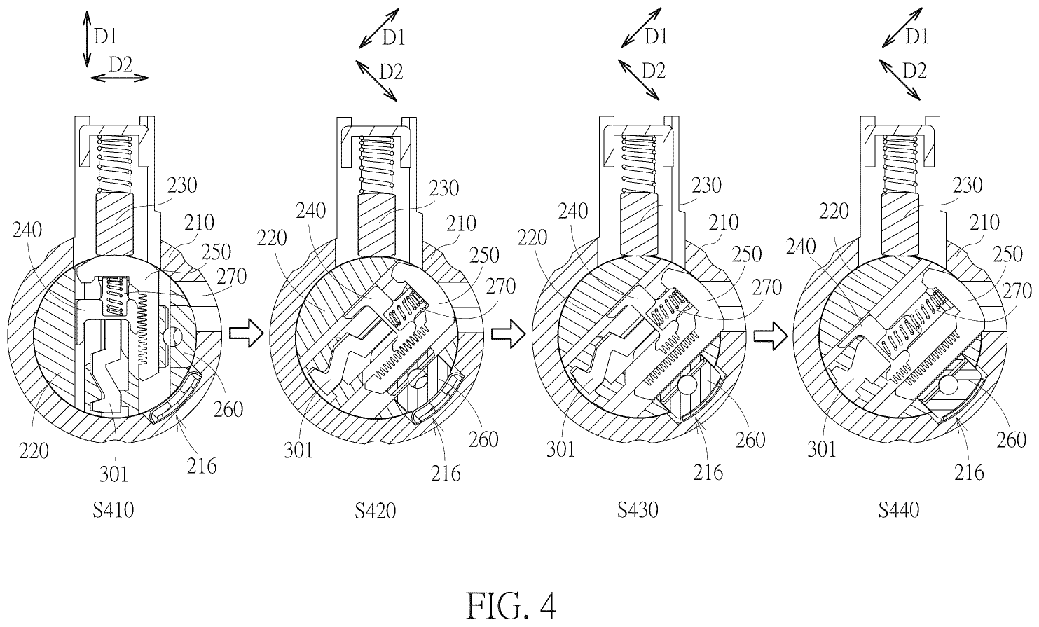

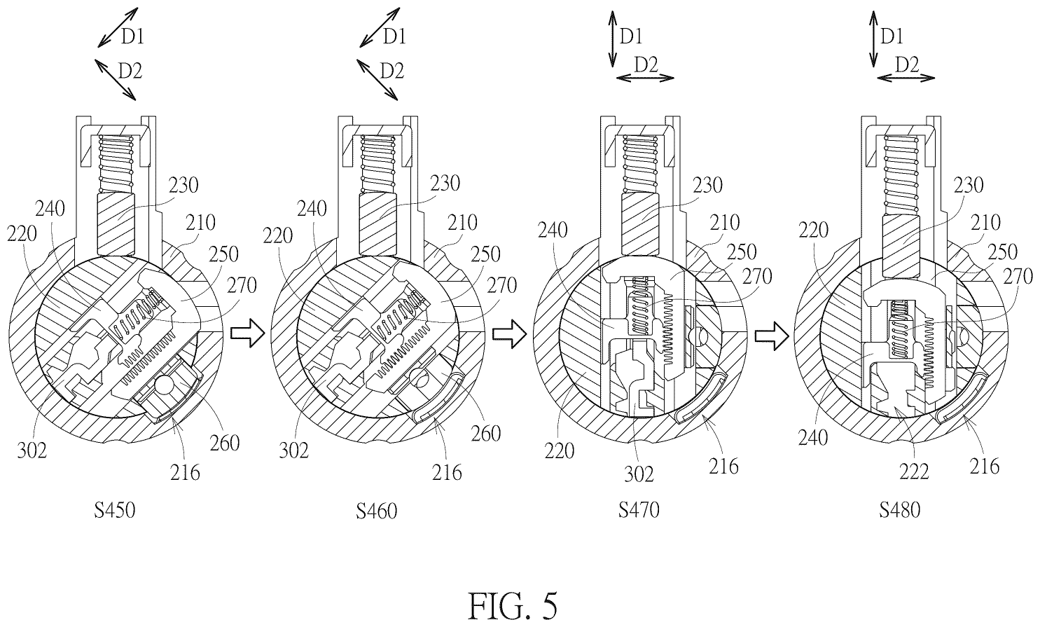

Please refer to FIG. 4 and FIG. 5, and FIG. 1 to FIG. 3 as well. FIG. 4 and FIG. 5 are diagrams showing processes of resetting the lock core device of the present invention. In the present embodiment, the lock core device 200 is preset to work with the first type key 301 for unlocking operation. Therefore, the plurality of tooth level blocks 240 are engaged with the plurality of positioning members 250 according to heights of tooth levels of the first type key 301. As shown in figures, in Step S410, when the first type key 301 is inserted into the keyway 222, the plurality of tooth level blocks 240 are configured to push the plurality of positioning members 250 upward, such that the plurality of lock balls 230 no longer extend into the plurality of slots 225 of the lock cylinder 220 (when the lock cylinder 220 is located at an initial position relative to the receiving sleeve 210, the plurality of lock ball holes 214 of the receiving sleeve 210 are respectively communicated with the plurality of slots 225 of the lock cylinder 220). In other words, the plurality of positioning members 250 are aligned with a shear line between the lock cylinder 220 and the receiving sleeve 210, such that the lock cylinder 220 is rotatable relative to the receiving sleeve 210. In Step S420, the first type key 301 is used to rotate the lock cylinder 220 relative to the receiving sleeve 210 from the initial position to a setting position, such that the setting rod 260 corresponds to a recessed structure 216 on the receiving sleeve 210. In Step S430, the setting tool 303 is inserted into the setting hole 224 of the lock cylinder 220 in order to move the setting rod 260 toward the recessed structure 216 of the receiving sleeve 210 along a width direction D2 of the keyway 222 (a direction perpendicular to the height direction D1 of the keyway 222). In addition, the setting rod 260 is configured to move the plurality of positioning members 250 relative to the lock cylinder 220 and the plurality of tooth level blocks 240 along the width direction D2 of the keyway 222 accordingly in order to disengage the plurality of positioning members 250 from the plurality of tooth level blocks 240. When the positioning members 250 are respectively disengaged from the tooth level blocks 240, the tooth level blocks 240 are movable relative to the positioning members 250 along the height direction D1 of the keyway 222. In Step S440, the first type key 301 is removed from the keyway 222 of the lock cylinder 220, and each of the tooth level blocks 240 is pushed by a spring 270 to return to a lowest position relative to the keyway 222. In Step S450, the second type key 302 is inserted into the keyway 222 to move the plurality of tooth level blocks 240 relative to the lock cylinder 220 and the plurality of positioning members 250 along the height direction D1 of the keyway 222, such that the height of the plurality of tooth level blocks 240 corresponds to heights of tooth levels of the second type key 302. In Step S460, the setting tool 303 is removed from the setting hole 224 of the lock cylinder 220, such that the setting rod 260 is moved away from the recessed structure 216 of the receiving sleeve 210 along the width direction D2 of the keyway 222 (correspondingly, the plurality of positioning members 250 are moved relative to the lock cylinder 220 and the plurality of tooth level blocks 240 along the width direction D2 of the keyway 222 toward the plurality of tooth level blocks 240), so as to engage the plurality of tooth level blocks 240 with the plurality of positioning members 250 respectively according to the heights of tooth levels of the second type key 302. In Step S470, the second type key 302 is used to rotate the lock cylinder 220 relative to the receiving sleeve 210 from the setting position to the initial position. In Step S480, the second type key 302 is removed from the keyway 222 of the lock cylinder 220 to complete the resetting processes of the lock core device 200 of the present invention. On the other hand, when the lock cylinder 220 is located at the initial position relative to the receiving sleeve 210, the plurality of lock ball holes 214 of the receiving sleeve 210 are respectively communicated with the plurality of slots 225 of the lock cylinder 220. Therefore, when the second type key 302 is removed from the keyway 222 of the lock cylinder 220, the plurality of lock balls 230 are configured to extend into the plurality of slots 225 of the lock cylinder 220 in order to prevent the lock cylinder 220 from rotating relative to the receiving sleeve 210.

According to the aforementioned arrangement, when the lock core device 200 is preset to work with the first type key 301 for unlocking operation, the lock core device 200 of the present invention can be reset to work with the second type key 302 for unlocking operation through the aforementioned resetting processes. Moreover, the resetting method of the lock core device of the present invention is also applicable to the same type key (having the same section contour) formed with teeth at different tooth levels. The resetting method of the lock core device of the present invention does not require replacement of the lock balls, such that complexity of resetting the lock core device is reduced.

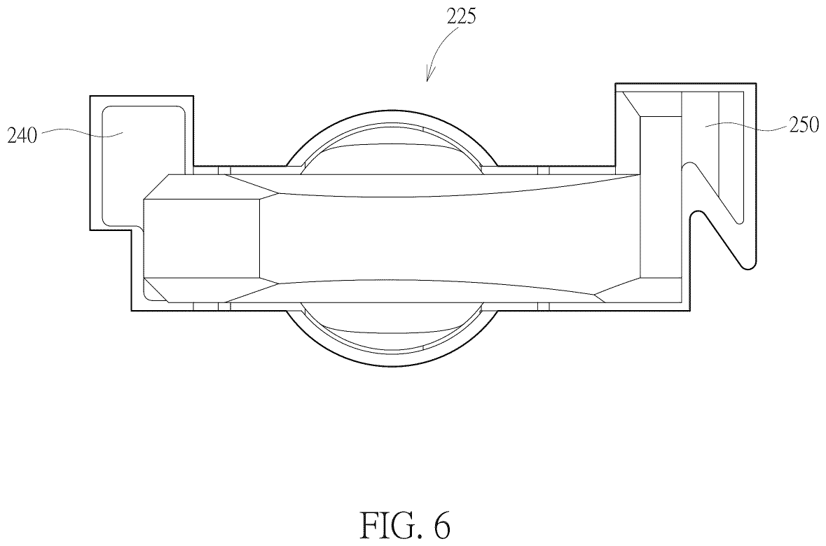

Please refer to FIG. 6. FIG. 6 is a diagram showing the slot of the lock cylinder of the present invention. As shown in FIG. 6, a shape of the slot 225 of the locking cylinder 220 corresponds to a shape of a portion of the tooth level block 240 and a portion of the positioning member 250. Therefore, the slot 225 is configured to allow the tooth level block 240 and the positioning member 250 to move in the lock cylinder 220 more stably. In addition, a shape of the middle portion of the slot 225 corresponds to a shape of the lock ball 230, so as to allow the lock ball 230 to extend into the slot 225.

In another embodiment of the present invention, the shapes of all or some of the slots 225 can be adjusted to increase difficulty in unlocking the lock by illegal picking or breaking.

In addition, in the lock core device 200 of the present invention, the plurality of tooth level blocks 240 are movable relative to the lock cylinder 220 only along the height direction D1 of the keyway 222, and the plurality of positioning members 250 are movable relative to the lock cylinder 220 along the height direction D1 of the keyway 222 and the width direction D2 of the keyway 222.

On the other hand, in Step S430 of the present embodiment, the setting tool 303 is inserted into the setting hole 224 of the lock cylinder 220 to drive the setting rod 260 to move, so as to further drive the plurality of positioning members 250 to disengage from the plurality of tooth level blocks 240, but the present invention is not limited thereto. Alternatively, in Step S430 of another embodiment of the present invention, the plurality of positioning members 250 is configured to be disengaged from the plurality of tooth level blocks 240 by other means, or the plurality of positioning members 250 is configured to be disengaged from the plurality of tooth level blocks 240 without the setting tool 303. For example, a user can manually operate the lock cylinder 220 to move the lock cylinder 220 axially relative to the receiving sleeve 210 to drive the plurality of positioning members 250 to move axially relative to the plurality of tooth level blocks 240 so as to disengage the plurality of positioning members 250 from the plurality of tooth level blocks 240; or by arranging a guide block (not shown in figures) connected to the plurality of positioning members 250 and a guide groove (not shown in figures) on the lock cylinder 220 or the receiving sleeve 210, the plurality of positioning members 250 can be driven by the guide block through the guide groove to be disengaged from the plurality of tooth level blocks 240 through specific operation steps, so as to achieve the purpose of disengaging the plurality of positioning members 250 from the plurality of tooth level blocks 240 without the setting tool 303. Correspondingly, in step S460, an operation corresponding to Step S430 (such as a reverse operation of Step S430) can also be performed to re-engage the plurality of positioning members 250 with the plurality of tooth level blocks 240.

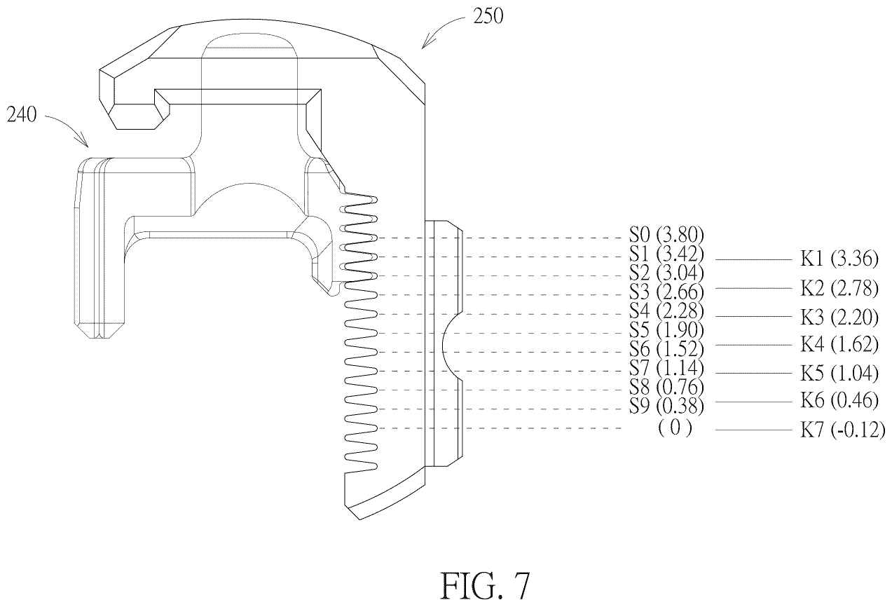

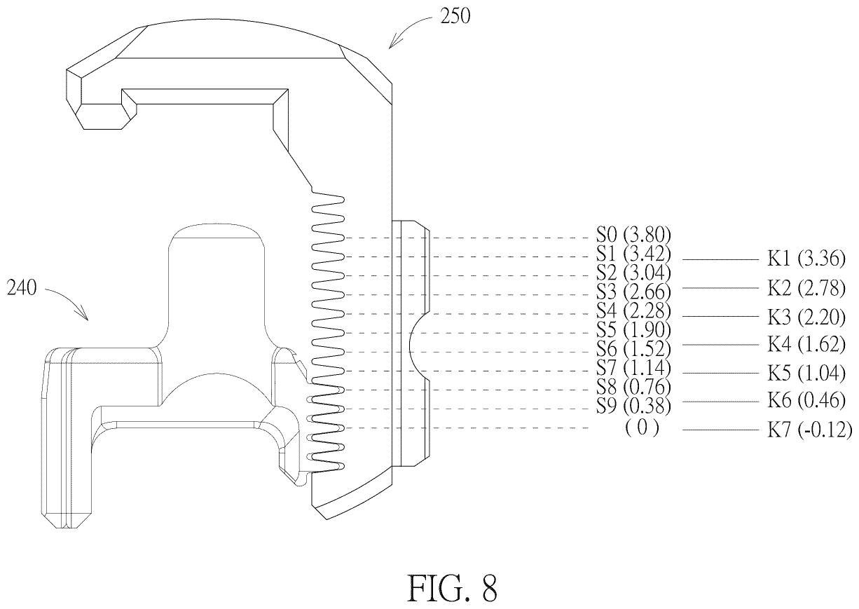

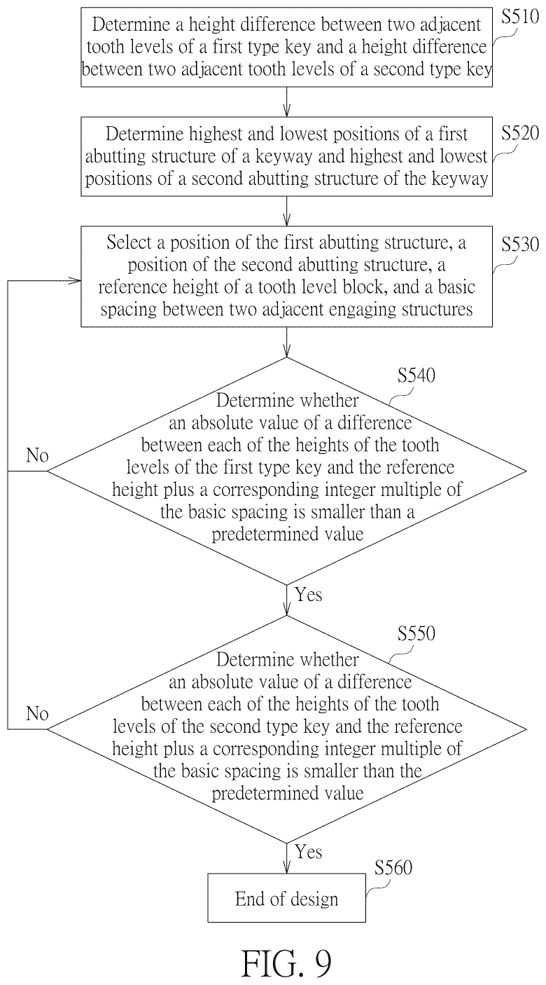

Please refer to FIG. 7 to FIG. 9, and refer to FIG. 1 to FIG. 5 as well. FIG. 7 is a diagram showing the tooth level block being engaged with the positioning member at a highest position, FIG. 8 is a diagram showing the tooth level block being engaged with the positioning member at a lowest position, and FIG. 9 is a flow chart of a lock core device design method of the present invention. The design method allows the lock core device 200 of the present invention to be applicable to two different types of keys (with different section contours and different tooth level configurations). In step S510, a height difference between two adjacent tooth levels of the first type key 301 and a height difference between two adjacent tooth levels of the second type key 302 are determined first. In the present embodiment of the present invention, the first type key 301 has ten different tooth levels (S0 to S9), and the height difference between two adjacent tooth levels is 0.38 mm; the second type key 302 has seven different tooth levels (K1 to K7), and the height difference between two adjacent tooth levels is 0.58 mm, but the present invention is not limited thereto. In the present embodiment, the first type key 301 is formed with five teeth with tooth levels selected from the ten different tooth levels (S0 to S9), and the second type key 302 is formed with five teeth with tooth levels selected from the seven different tooth levels (K1 to K7). However, a total number of teeth of the first type key 301 and a total number of teeth of the second type key 302 in the present invention are not limited thereto. The total number of teeth of the first type key 301 is equal to the total number of the lock balls 230, and the total number of teeth of the second type key 302 is equal to the total number of the lock balls 230.

In Step S520, highest and lowest positions of the first abutting structure 223a of the keyway 222 of the lock cylinder 220 and highest and lowest positions of the second abutting structure 223b of the keyway 222 of the lock cylinder 220 are determined according to the first section contour A of the first type key 301 and the second section contour B of the second type key 302. The first abutting structure 223a of the keyway 222 is configured to allow the first type key 301 to abut against in order to determine the first position P1 of the bottom of the first type key 301 relative to the keyway 222 along the height direction of the keyway 222, and the second abutting structure 223b of the keyway 222 is configured to allow the second type key 302 to abut against in order to determine the second position P2 of the bottom of the second type key 302 relative to the keyway 222 along the height direction of the keyway 222.

The highest and lowest positions of the first abutting structure 223a of the first type key 301 are determined according to a diameter of the lock cylinder 220, highest and lowest positions of the positioning member 250 and the tooth level block 240. The method for determining the highest and lowest positions of the second abutting structure 223b of the second type key 302 is similar to the method for determining the first abutting structure 223a as described above. Therefore, no further illustration is provided.

In Step S530, a position of the first abutting structure 223a, a position of the second abutting structure 223b, a reference height of the tooth level block 240, and a basic spacing between two adjacent engaging structures 252 are selected. In the present embodiment of the present invention, the lowest position of the tooth level block 240 is selected as the reference height (the reference height is set as 0 mm), and the basic spacing between two adjacent engaging structures of the plurality of engaging structures 252 on the positioning member 250 is 0.38 mm (identical to the height difference between two adjacent tooth levels of the first type key 301), but the present invention is not limited thereto. The lowest position of the tooth level block 240 is the lowest position where the tooth level block 240 can be engaged with the positioning member 250 when a top end of the positioning member 250 is aligned with the shear line between the locking cylinder 220 and the receiving sleeve 210. When the position of the first abutting structure 223a and the position of the second abutting structure 223b are selected, the heights of the tooth levels of the first type key 301 and the heights of the tooth levels of the second type key 302 can be further determined. For example, the position of the first abutting structure 223a is selected, such that the height of the tooth level S9 of the first type key 301 is higher than the reference height by 0.38 mm. Therefore, the height of the tooth level S9 of the first type key 301 is 0.38 mm; the height of the tooth level S8 of the first type key 301 is 0.76 mm; the height of the tooth level S7 of the first type key 301 is 1.14 mm, and so on. Furthermore, the position of the second abutting structure 223b is selected, such that the height of the tooth level K7 of the second type key 302 is lower than the reference height by 0.12 mm. Therefore, the height of the tooth level K7 of the second type key 302 is-0.12 mm; the height of the tooth level K6 of the second type key 302 is 0.46 mm; the height of the tooth level K5 of the second type key 302 is 1.04 mm, and so on.

In Step S540, determine whether an absolute value of a difference between each of the heights of the tooth levels of the first type key 301 and the reference height plus a corresponding integer multiple of the basic spacing is smaller than a predetermined value. If so, go to Step S550. If not, return to Step S530 to reselect the position of the first abutting structure 223a, the position of the second abutting structure 223b, the reference height of the tooth level block 240, and the basic spacing between two adjacent engaging structures 252. The height of tooth level in Step S540 and Step S550 is a distance between a position of each of the tooth levels and the reference height of the tooth level block 240 along the height direction D1 when a corresponding key is inserted into the keyway 222. In the present embodiment of the present invention, the predetermined value is one third of the basic spacing (about 0.127 mm), but the present invention is not limited thereto. The predetermined value can be determined according to design requirements. The smaller the predetermined value is, the fewer errors will occur during operation of the lock core device 200 of the present invention. In the present embodiment of the present invention, a difference between the height of the tooth level S9 of the first type key 301 and the reference height is equal to the basic spacing, and the height difference between two adjacent tooth levels of the first type key 301 is equal to the basic spacing. Therefore, the difference between each of the heights of the tooth levels of the first type key 301 and the reference height plus a corresponding integer multiple of the basic spacing is 0 mm (smaller than the predetermined value).

In Step S550, determine whether an absolute value of a difference between each of the heights of the tooth levels of the second type key 302 and the reference height plus a corresponding integer multiple of the basic spacing is smaller than the predetermined value. If so, go to Step S560. If not, return to Step S530 to reselect the position of the first abutting structure 223a, the position of the second abutting structure 223b, the reference height of the tooth level block 240, and the basic spacing between two adjacent engaging structures 252. In the present embodiment of the present invention, the absolute value of the difference (−0.12 mm) between the height (−0.12 mm) of the tooth level K7 of the second type key 302 and the reference height (0 mm) plus 0 times the basic spacing is smaller than the predetermined value (0.127 mm); the absolute value of the difference (0.12 mm) between the height (0.46 mm) of the tooth level K6 of the second type key 302 and the reference height (0 mm) plus 1 times the basic spacing (−0.38 mm) is smaller than the predetermined value (0.127 mm). Other absolute values of the differences for the tooth levels K5 to K1 of the second type key 302 are also calculated in the same manner in order to determine whether the absolute value of the difference between each of the heights of the tooth levels and the reference height plus a corresponding integer multiple of the basic spacing is smaller than the predetermined value (0.127 mm). Therefore, the absolute value of the difference between the height of each tooth level of the second type key 302 and the reference height plus a corresponding integer multiple of the basic spacing is smaller than the predetermined value. On the other hand, the tooth level K1 of the second type key 302 and the tooth level S1 of the first type key 301 correspond to the same tooth level block height; the tooth level K2 of the second type key 302 and the tooth level S3 of the first type key 301 correspond to the same tooth level block height; the tooth level K3 of the second type key 302 and the tooth level S4 of the first type key 301 correspond to the same tooth level block height; the tooth level K4 of the second type key 302 and the tooth level S6 of the first type key 301 correspond to the same tooth level block height; the tooth level K5 of the second type key 302 and the tooth level S7 of the first type key 301 correspond to the same tooth level block height; the tooth level K6 of the second type key 302 and the tooth level S9 of the first type key 301 correspond to the same tooth level block height.

In Step S560, when each of the heights of the tooth levels of the first type key 301 and each of the heights of the tooth levels of the second type key 302 meet the aforementioned conditions, the lock core device 200 of the present invention is applicable to the first type key 301 and the second type key 302 (with different section contours and different tooth level configurations). Therefore, processes of the design method of the lock core device 200 of the present invention are completed.

In addition, in the design method of the lock core device 200 of the present invention, the aforementioned steps need not be in the exact order shown. That is, the order of the steps can be changed and other steps can be inserted in between.

Furthermore, in the present embodiment of the present invention, the height difference between two adjacent tooth levels of the first type key 301 is a positive integer multiple of the basic spacing, and the height difference between two adjacent tooth levels of the second type key 302 is not a positive integer multiple of the basic spacing, but the present invention is not limited thereto. In other embodiments, the basic spacing between two adjacent engaging structures 252 can be set to be smaller than the height difference between two adjacent tooth levels of the first type key 301 (0.38 mm) and smaller than the height difference between two adjacent tooth levels of the second type key 302 (0.58 mm), for example, the basic spacing can be set as 0.19 mm; or the basic spacing between two adjacent engaging structures 252 can be set to be between the height difference between two adjacent tooth levels of the first type key 301 (0.38 mm) and the height difference between two adjacent tooth levels of the second type key 302 (0.58 mm), for example, the basic spacing can be set as 0.39 mm.

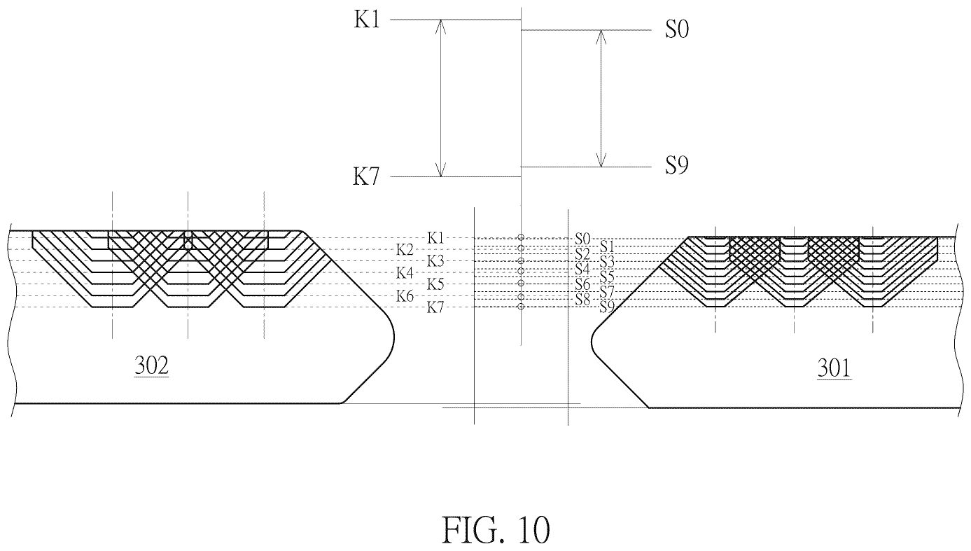

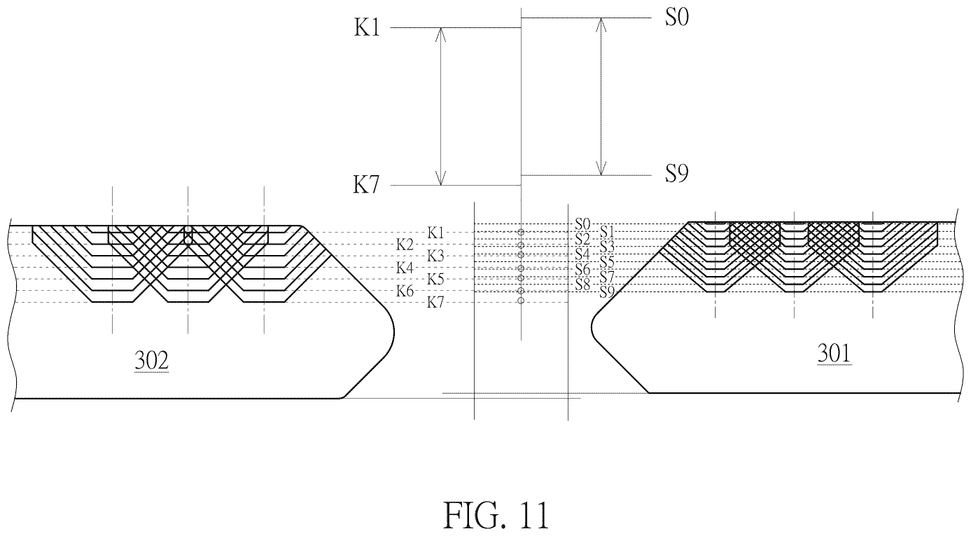

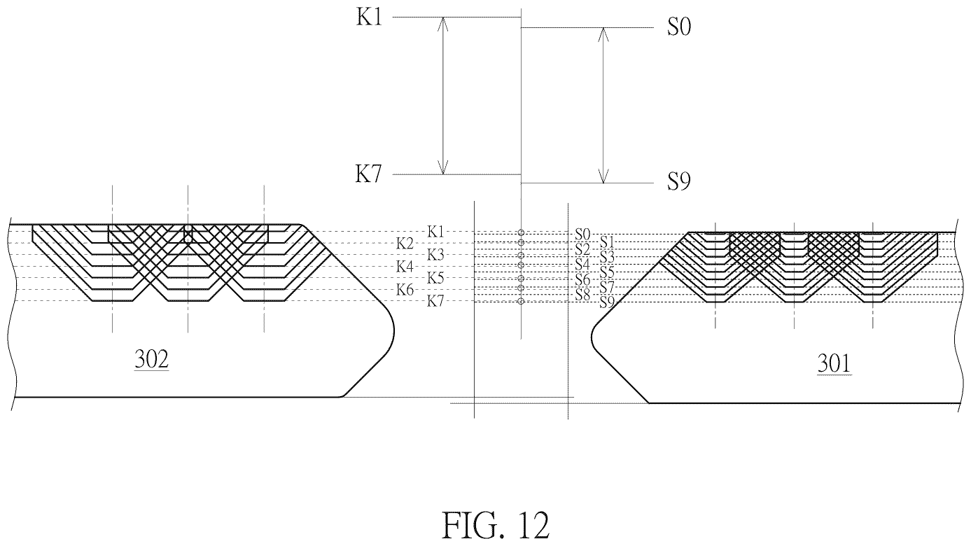

In addition, in the embodiment of the present invention, the highest tooth level S0 of the first type key 301 is higher than the highest tooth level K1 of the second type key 302, and the lowest tooth level S9 of the first type key 301 is higher than the lowest tooth level K7 of the second type key 302, but the present invention is not limited thereto. In other embodiments of the present invention, the highest tooth level S0 of the first type key 301 can be different from the highest tooth level K1 of the second type key 302, and the lowest tooth level S9 of the first type key 301 can be different from the lowest tooth level K7 of the second type key 302. For example, in another embodiment of the present invention as shown in FIG. 10, the highest tooth level S0 of the first type key 301 is lower than the highest tooth level K1 of the second type key 302, and the lowest tooth level S9 of the first type key 301 is higher than the lowest tooth level K7 of the second type key 302; in another embodiment of the present invention as shown in FIG. 11, the highest tooth level S0 of the first type key 301 is higher than the highest tooth level K1 of the second type key 302, and the lowest tooth level S9 of the first type key 301 is higher than the lowest tooth level K7 of the second type key 302; in another embodiment of the present invention as shown in FIG. 12, the highest tooth level S0 of the first type key 301 is lower than the highest tooth level K1 of the second type key 302, and the lowest tooth level S9 of the first type key 301 is lower than the lowest tooth level K7 of the second type key 302.

According to the aforementioned arrangement, although the first type key 301 and the second type key 302 have different section contours, and the first type key 301 and the second type key 302 have different tooth level configurations (the height difference between two adjacent tooth levels of the first type key 301 is different from the height difference between two adjacent tooth levels of the second type key 302, and the total number of tooth levels of the first type key 301 is different from the total number of tooth levels of the second type key 302), the lock core device 200 of the present invention can be easily reset to work with two different types of keys.

In contrast to the prior art, the lock core device 200 of the present invention is applicable to two different types of keys (with different section contours and different tooth level configurations). The lock core device resetting method of the present invention does not require replacement of the lock balls, so as to reduce complexity of resetting the lock core device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lock core device resetting method, comprising:
providing a lock core device, wherein the lock core device comprises a receiving sleeve, a lock cylinder rotatable relative to the receiving sleeve, a plurality of tooth level blocks movably arranged in the lock cylinder, and a plurality of positioning members movably arranged in the lock cylinder, wherein the plurality of tooth level blocks are respectively engaged with the plurality of positioning members according to heights of tooth levels of a first type key;
inserting the first type key into a keyway of the lock cylinder and using the first type key to rotate the lock cylinder relative to the receiving sleeve from a first predetermined position to a second predetermined position;
disengaging the plurality of positioning members from the plurality of tooth level blocks;
removing the first type key from the lock cylinder and inserting a second type key into the keyway of the lock cylinder to move the plurality of tooth level blocks relative to the lock cylinder, wherein a section contour of the second type key is different from a section contour of the first type key;
engaging the plurality of tooth level blocks with the plurality of positioning members respectively according heights of tooth levels of the second type key;
using the second type key to rotate the lock cylinder relative to the receiving sleeve from the second predetermined position to the first predetermined position; and
removing the second type key from the lock cylinder.

2. The lock core device resetting method of claim 1, wherein disengaging the plurality of positioning members from the plurality of tooth level blocks is moving the plurality of positioning members relative to the lock cylinder along a first direction to disengage the plurality of positioning members from the plurality of tooth level blocks; wherein removing the first type key from the lock cylinder and inserting the second type key into the keyway of the lock cylinder to move the plurality of tooth level blocks relative to the lock cylinder is removing the first type key from the lock cylinder and inserting the second type key into the keyway of the lock cylinder to move the plurality of tooth level blocks relative to the lock cylinder along a second direction; wherein the second direction is identical to a height direction of the keyway, and the first direction is perpendicular to the second direction.

3. The lock core device resetting method of claim 2, wherein the plurality of tooth level blocks are movable relative to the lock cylinder only along the second direction, and the plurality of positioning members are movable relative to the lock cylinder along the first direction and the second direction.

4. The lock core device resetting method of claim 2, wherein moving the plurality of positioning members relative to the lock cylinder along the first direction to disengage the plurality of positioning members from the plurality of tooth level blocks is inserting a setting tool into a setting hole of the lock cylinder to move the plurality of positioning members relative to the lock cylinder along the first direction to disengage the plurality of positioning members from the plurality of tooth level blocks.

5. A lock core device design method, wherein the lock core device comprises a receiving sleeve, a lock cylinder rotatable relative to the receiving sleeve, a plurality of tooth level blocks movably arranged in the lock cylinder, and a plurality of positioning members movably arranged in the lock cylinder, the method comprising:
determining a contour of a keyway of the lock cylinder according to a first section contour of a first type key and a second section contour of a second type key, wherein the keyway is formed with a first abutting structure configured to allow the first type key to abut against, and a second abutting structure configured to allow the second type key to abut against;
selecting a reference height of the tooth level block and a basic spacing between two adjacent engaging structures of the plurality of engaging structures on the positioning member, wherein the tooth level block is configured to be engaged with the engaging structure on the positioning member;
determining whether an absolute value of a difference between each of the heights of tooth levels of the first type key and the reference height plus a corresponding integer multiple of the basic spacing is smaller than a predetermined value according to a position of the first abutting structure; and
determining whether an absolute value of a difference between each of the heights of tooth levels of the second type key and the reference height plus a corresponding integer multiple of the basic spacing than the predetermined value according to a position of the second abutting structure.

6. The lock core device design method of claim 5, wherein the predetermined value is one third of the basic spacing.

7. The lock core device design method of claim 5, wherein the first type key is not configured to abut against the second abutting structure, and the second type key is not configured to abut against the first abutting structure.

8. The lock core device design method of claim 5, further comprising determining a height difference between two adjacent tooth levels of the first type key and determining a height difference between two adjacent tooth levels of the second type key.

9. The lock core device design method of claim 5, wherein the height difference between two adjacent tooth levels of the second type key is not a positive integer multiple of the basic spacing.

10. The lock core device design method of claim 5, wherein the height difference between two adjacent tooth levels of the first type key is a positive integer multiple of the basic spacing.

11. The lock core device design method of claim 5, wherein the height difference between two adjacent tooth levels of the first type key is different from the height difference between two adjacent tooth levels of the second type key.

12. The lock core device design method of claim 5, wherein a total number of tooth levels of the first type key is different from a total number of tooth levels of the second type key.

13. The lock core device design method of claim 5, wherein the first section contour of the first type key is different from the second section contour of the second type key.

14. A lock core device, comprising:
a receiving sleeve;
a lock cylinder rotatable relative to the receiving sleeve;
a plurality of tooth level blocks movably arranged in the lock cylinder; and
a plurality of positioning members movably arranged in the lock cylinder;
wherein the lock cylinder is formed with a keyway configured to selectively receive a first type key with a first section contour or a second type key with a second section contour different from the first section contour;
wherein the plurality of tooth level blocks are configured to be engaged with the plurality of positioning members respectively according to heights of tooth levels of the first type key or heights of tooth levels of the second type key;
wherein a highest tooth level of the first type key is different from a highest tooth level of the second type key, and/or a lowest tooth level of the first type key is different from a lowest tooth level of the second type key.

15. A lock core device, comprising:
a receiving sleeve; and
a lock cylinder rotatable relative to the receiving sleeve, the lock cylinder being formed with a keyway configured to selectively receive a first type key with a first section contour or a second type key with a second section contour different from the first section contour;
wherein a first side of the keyway is formed with a first abutting structure configured to allow the first type key to abut against in order to position a bottom of the first type key relative to the keyway along a height direction of the keyway;
wherein a second side of the keyway is formed with a second abutting structure configured to allow the second type key to abut against in order to position a bottom of the second type key relative to the keyway along the height direction of the keyway;
wherein the first side and the second side are opposite sides.

16. A lock core device, comprising:
a receiving sleeve; and
a lock cylinder rotatable relative to the receiving sleeve, the lock cylinder being formed with a keyway configured to selectively receive a first type key or a second type key;
wherein the keyway is formed with a first abutting structure configured to allow the first type key to abut against in order to position a bottom of the first type key at a first position relative to the keyway along a height direction of the keyway;
wherein the keyway is formed with a second abutting structure configured to allow the second type key to abut against in order to position a bottom of the second type key at a second position relative to the keyway along the height direction of the keyway;
wherein a distance between the first position and a bottom of the keyway is different from a distance between the second position and the bottom of the keyway.

17. A lock core device, comprising:
a receiving sleeve;
a lock cylinder rotatable relative to the receiving sleeve;
a plurality of tooth level blocks movably arranged in the lock cylinder; and
a plurality of positioning members movably arranged in the lock cylinder;
wherein the lock cylinder is formed with a keyway configured to selectively receive a first type key or a second type key;
wherein each of the positioning members is formed with a plurality of engaging structures, and a basic spacing is defined between two adjacent engaging structures;
wherein the plurality of tooth level blocks are configured to be engaged with the engaging structures of the plurality of positioning members respectively according to heights of tooth levels of the first type key or heights of tooth levels of the second type key;
wherein a height difference between two adjacent tooth levels of one of the first type key and the second type key is not a positive integer multiple of the basic spacing.

18. The lock core device of claim 17, wherein the height difference between two adjacent tooth levels of the first type key is different from the height difference between two adjacent tooth levels of the second type key.

19. The lock core device of claim 17, wherein a total number of tooth levels of the first type key is different from a total number of tooth levels of the second type key.

20. The lock core device of claim 17, wherein the first type key has a first section contour, and the second type key has a second section contour different from the first section contour.

21. A lock core device, comprising:
a receiving sleeve;
a lock cylinder rotatable relative to the receiving sleeve;
a plurality of tooth level blocks movably arranged in the lock cylinder; and
a plurality of positioning members movably arranged in the lock cylinder;
wherein the lock cylinder is formed with a keyway configured to selectively receive a first type key with a first section contour or a second type key with a second section contour, the first section contour being different from the first section contour;
wherein each of the positioning members is formed with a plurality of engaging structures, and the plurality of tooth level blocks are configured to be engaged with the engaging structures of the plurality of positioning members respectively according to heights of tooth levels of the first type key or heights of tooth levels of the second type key;
wherein a height difference between two adjacent tooth levels of the first type key is different from a height difference between two adjacent tooth levels of the second type key.

22. The lock core device of claim 21, wherein a total number of tooth levels of the first type key is different from a total number of tooth levels of the second type key.
